(19) United States
(12) Patent Application Publication
(10) Pub. No.: US 2007/0022214 A1
(43) Pub. Date: Jan. 25, 2007

(54) Transaction management apparatus and method

(76) Inventor: Nicole Truelle Harcourt, Pinner (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/282,479

(22) Filed: Nov. 21, 2005

(30) Foreign Application Priority Data
Jul. 22, 2005 (GB) 0515160.0

(51) Int. Cl. G06F 15/16

(52) U.S. Cl. 709/246

(57) ABSTRACT

There is described a network apparatus for administering product purchases. The network apparatus includes means for receiving product data from one or more vendors, means for advertising the product data using a plurality of electronic sales channels, and means for receiving purchase requests via the electronic sales channels. In this way, the network apparatus acts as an intermediary, or broker, between vendors and customers. There is also described an electronic auction system in which bidders make their bids using their cellular phones.

This application claims the right to priority under 35 U.S.C. §119 based on British Patent Application Number 0515160.0 filed on 22 Jul. 2005, which is hereby incorporated by reference herein in its entirety as if fully set forth herein.

### FIELD OF THE INVENTION

This invention relates to a system, and apparatus forming part of the system, for managing transactions, and operational methods employed by the system.

### BACKGROUND OF THE INVENTION

The introduction in recent years of personal video recorders which record television programmes to hard disk is initiating a fundamental change in television viewing habits. Of particular importance to retailers, personal video recorders allow a viewer to skip advertisement breaks. Retailers are therefore looking for new ways to advertise their products on television. One way which has already been widely adopted is the use of shopping channels which exclusively show promotional trailers for products. However, many consumers actively dislike shopping channels.

It has been recognised for a number of years that the appearance of a product in a successful television show can result in increased sales of that product. This has led to retailers actively trying to place their products in popular television shows. A problem with such product placement is that although a viewer may wish to purchase a product seen in a show, the viewer does not immediately know where to purchase the product. There is accordingly a risk that the viewer does not find out where to buy the product, or that in the time needed to find out where to purchase the product the viewer loses interest in purchasing the product.

Various attempts have been made at facilitating the purchase of products viewed in television programmes. For example, Delivery Agent, Inc (whose current web address is www.deliveryagent.com) provide technology to television companies, film companies and the like which allow consumers to purchase products placed in television programmes or films through websites associated with the television programmes or films.

An aim of the present invention is to provide an alternative product purchasing system.

### SUMMARY OF THE INVENTION

According to an aspect of the present invention, there is provided a network apparatus for administering product purchases. The network apparatus includes means for receiving product data from one or more vendors, means for advertising the product data using a plurality of electronic sales channels, and means for receiving purchase requests via the electronic sales channels. In this way, the network apparatus acts as an intermediary, or broker, between vendors and customers.

Preferably, the sales channels include interactive television, the internet and the mobile internet.

In a preferred embodiment, the network apparatus includes means for associating one or more products with a media event such as a television show. In this way, products placed in a media event may be easily identified by a customer by reference to the media event.

In a preferred embodiment, the network apparatus is operable to administer an auction for a product, and the purchase request is in the form of a bid. This is particularly well suited to products which have been placed in a media event because the actual product used in the media event can be auctioned. For example, an item of clothing worn by a famous film star in a television show can be auctioned.

According to another aspect of the invention, there is provided an apparatus which is operable to administer an auction over the mobile internet. The apparatus is operable to send details of the auction to a cellular phone which is operable to access the mobile internet, and receive bid information entered into the cellular phone and then transmitted by the cellular phone.

### BRIEF DESCRIPTION OF THE DRAWINGS

An embodiment of the present invention will now be described with reference to the accompanying Figures, in which:

FIG. 1 schematically shows the main components of a product purchasing system;

FIG. 2 schematically shows the main components of a central administration server forming part of the product purchasing system illustrated in FIG. 1;

FIG. 3 schematically shows the main components of an entry in a vendor database stored in the central administration server illustrated in FIG. 2;

FIG. 4 schematically shows the main components of an entry in a product database stored in the central administration server illustrated in FIG. 2;

FIG. 5 schematically shows the main components of an entry in a show database stored in the central administration server illustrated in FIG. 2;

FIG. 6 schematically shows the main components of an entry in a customer database stored in the central administration server illustrated in FIG. 2;

FIG. 7 schematically shows the main components of an entry in a basket database stored in the central administration server illustrated in FIG. 2;

FIG. 8 schematically shows the main components of an entry in an order database stored in the central administration server illustrated in FIG. 2;

FIG. 9 schematically shows the main components of an entry in an auction database stored in the central administration server illustrated in FIG. 2;

FIG. 10 is a flow chart schematically showing the operations performed by the central administration server during a customer session;

FIG. 11 is a flow chart schematically showing the main operations performed by the central administration server when a customer purchases a product; and

FIG. 12 is a flow chart schematically showing the main operations performed by the central administration server when a customer bids for a product under auction.

### DETAILED DESCRIPTION

System Overview

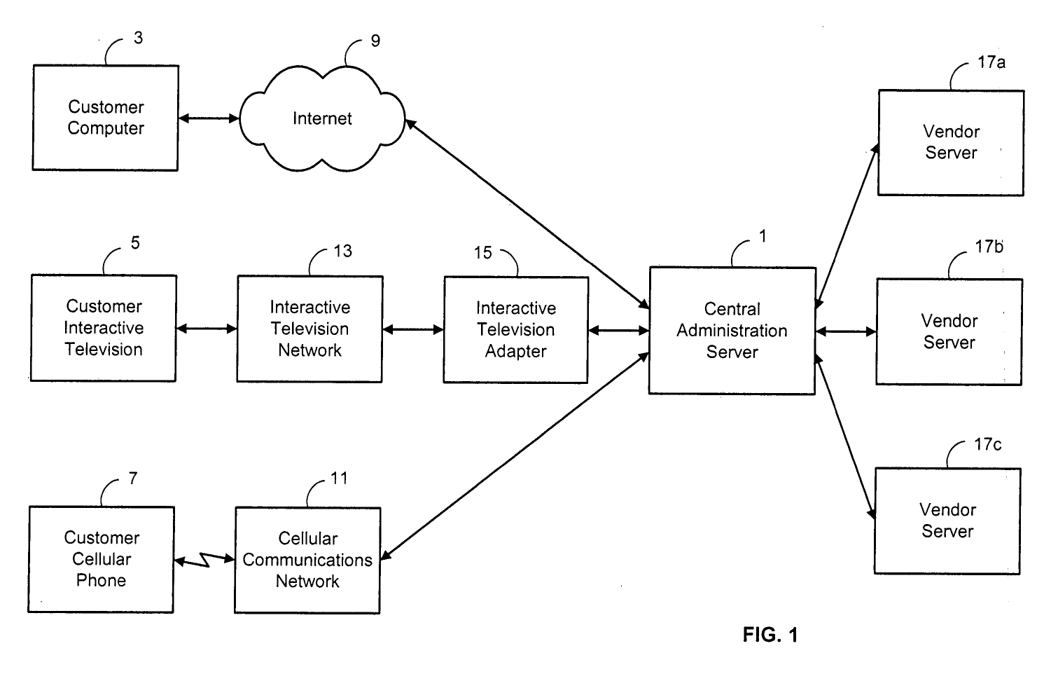

As shown in overview in FIG. 1, in the product purchasing system of the present invention a central administration server 1 allows the purchasing of products, which may be goods or services, from multiple vendors through multiple sales platforms. In this embodiment, the central administration server 1 is run by an administration company which liaises with television companies to feature the products or services of the vendors in television programmes. A viewer of the resulting television programme is then able to purchase the goods or services by either:
accessing the central administration server 1 using a conventional computer 3 (sometimes called e-commerce);
accessing the central administration server 1 using the interactive capability of a conventional interactive television 5 (sometimes called t-commerce); and
accessing the central administration server 1 using a conventional cellular phone 7 (sometimes called m-commerce).

As schematically shown in FIG. 1, the customer computer 1 is connected to the central administration server 1 via the internet 9, and the customer cellular phone 7 is connected to the central administration server 1 via a conventional cellular communications network 11. The customer interactive television 5 is connected to a conventional interactive television network 13, which is connected to the central administration server 1 via an interactive television adapter 15. The purpose of the interactive television adapter 15 is to convert the signals received from the interactive television network 13 into a format which is recognisable by the central administration server 1, and vice versa.

Each vendor has an associated vendor server, three of which are shown for exemplary purposes in FIG. 1 referenced 17a to 17c, which uploads details of products or services offered by that vendor to the central administration server 1. As will be discussed in more detail hereafter, the central administration server 1 records in which television shows products are placed, and a prospective customer is able to view products associated with a television show by accessing the central administration server 1. If a customer wishes to purchase a product, the customer sends a purchase request to the central administration server 1 which collates details of the purchase and forwards the details to the appropriate vendor server 17 for processing. Alternatively, some products may be purchased by auction, in which case a customer sends a bid to the central administration server 1 which determines the highest bid and forwards the details of the highest bid to the appropriate vendor server 17 for processing.

It will be appreciated that, in practice, all of the above network arrangements to some extent include common networks. In particular, the central administration server 1 is connected to a communications network through which the communications with the customer computer 3, the customer interactive television 5, the customer cellular phone 7 and the vendor servers 17 pass.

The Central Administration Server

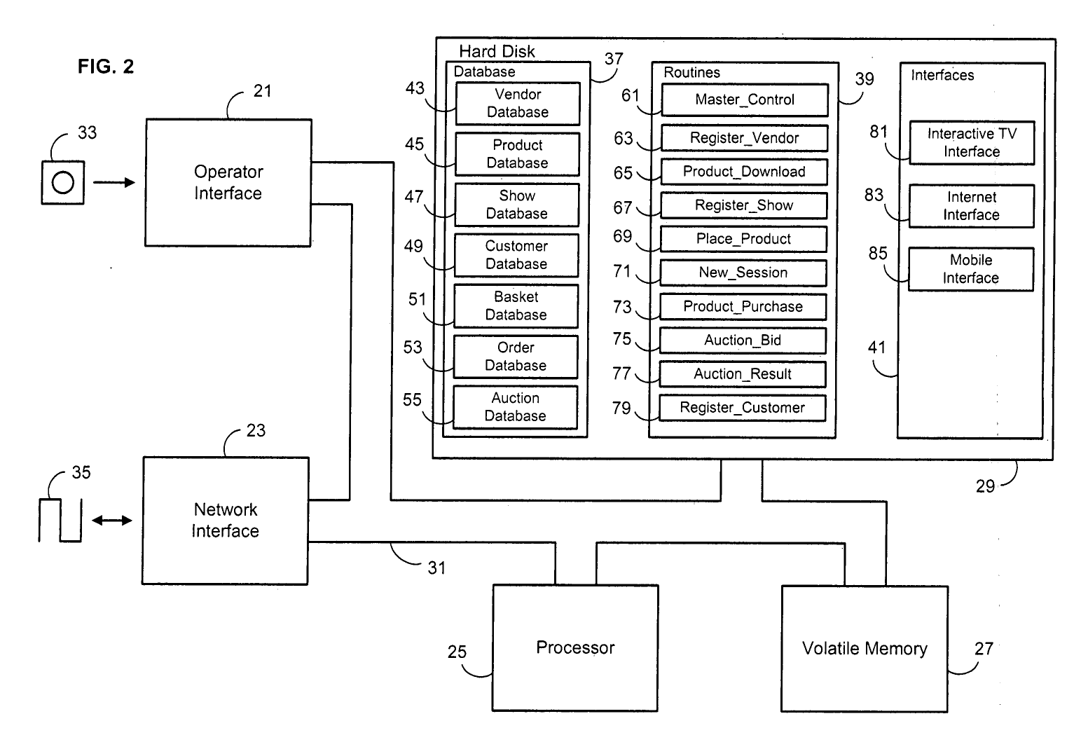

The central administration server 1 will now be discussed in more detail with reference to FIGS. 2 to 12. As schematically shown in FIG. 2, the central administration server 1 has an operator interface 21, a network interface 23, a processor 25, a volatile memory 27 and a hard disk 29 which are interconnected by a bus system 31.

In this embodiment, the operator interface 21 includes a keyboard for allowing an operator to enter data into the central administration server 1 and a display for allowing an operator to read data produced by the central administration server 1. The operator interface 21 also includes a CD-ROM reader/writer via which data stored on a CD-ROM 33 can be input into the central administration server 1 or data may be written onto a recordable CD-ROM 33.

The network interface 23 receives data from remote devices and outputs data to remote devices in the form of a signal 35.

The processor 25 performs processing operations in accordance with program routines stored in the hard disk 29. These program routines may be either stored during manufacture, or input to the central administration server 1 via the operator interface 21 or the network interface 23. The program routines process data stored in the hard disk 29 and data received via the operator interface 21 or the network interface 23 using the volatile memory 27 as working memory. Further, portions of the data stored in the hard disk 29 are dynamically uploaded into the volatile memory 27 in a conventional manner to increase the processing speed.

The hard disk 29 stores a database memory 37, a routines memory 39 and an interfaces memory 41.

The database memory 37 stores a vendor database 43, a product database 45, a show database 47, a customer database 49, a basket database 51, an order database 53 and an auction database 55.

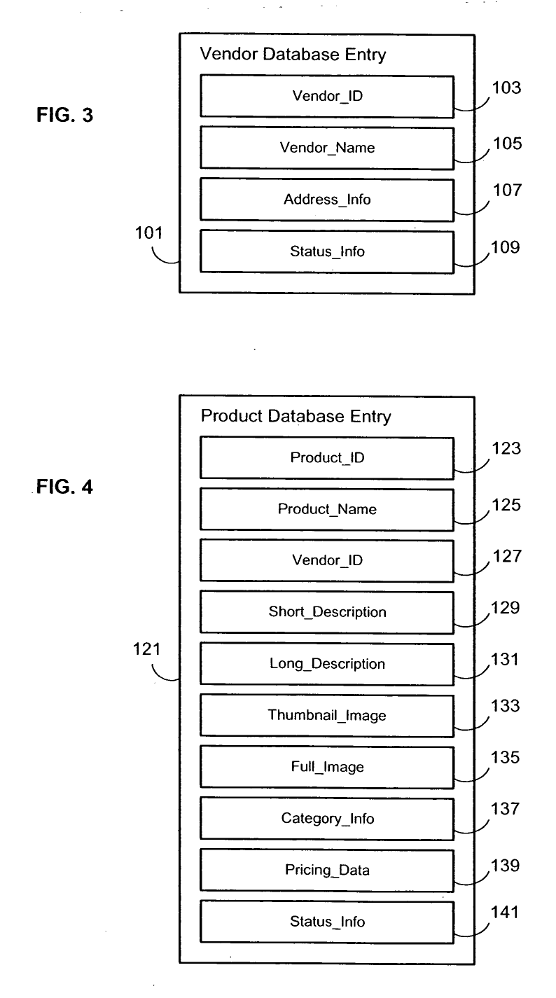

The vendor database 43 stores details for each vendor. As shown in FIG. 3, an entry 101 in the vendor database 43 has:
a vendor_ID field 103 which is a unique number assigned to the vendor by the central administration server 1;
a vendor_name field 105 storing the name of the vendor;
an address_info field 107 storing address information for the vendor, including postal address, IP address and contact information; and
a status_info field 109 storing details of the status of the vendor.

The product database 45 stores product data associated with each product. As shown in FIG. 4, an entry 121 in the product database 45 has:
a product_ID field 123 storing a unique number allocated to the product by the central administration server;
a product_name field 125 storing a name for the product;
a vendor_ID field 127 storing the unique vendor_ID number for the vendor offering the product for sale;
a short_description field 129 storing a short description of the product;
a long_description field 131 storing a longer description of the product;
a thumbnail_image field 133 storing a low resolution image of the product;
a full_image field 135 storing a high resolution image of the product;
a category_info field 137 storing categorisation information;
a pricing_data field 139 storing pricing data for the product, including details of the portions of the product price which are paid as commission to the company running the central administration server 1 and are paid as tax;
a status_info field 141 storing details of the availability of the product, e.g. a date range over which the product is available.

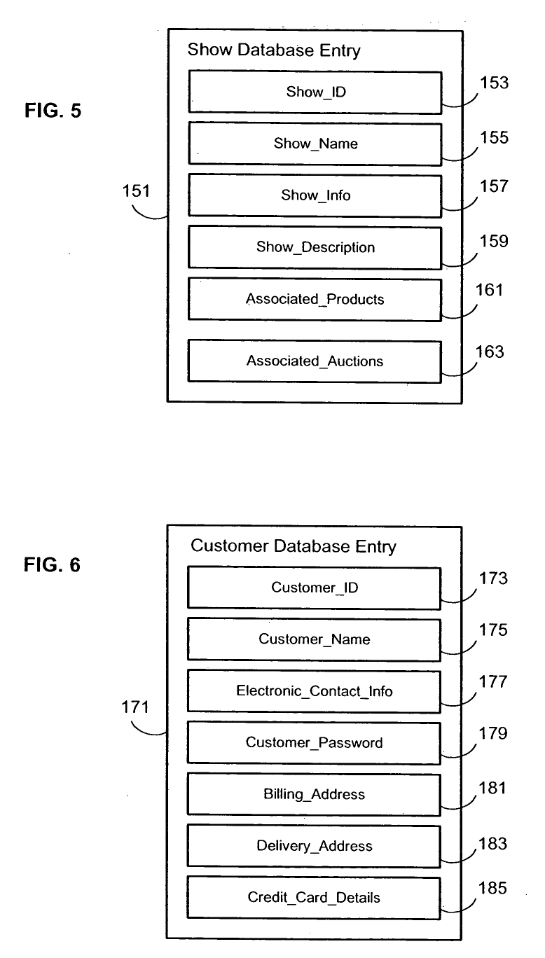

The show database 47 stores information relating to each television show in which products from the product database 45 are placed. As shown in FIG. 5, an entry 151 in the show database 47 has:
a show_ID field 153 storing a unique number assigned by the central administration server 1 to the show;
a show_name field 155 storing the name of the show;
a show_info field 157 storing information concerning the television company producing the show;
a show_description field 159 storing a description of the show;
an associated_products field 161 storing a list of the products for purchase placed in the show, with the products being identified by their unique product_ID numbers; and
an associated_auctions field 163 storing a list of the auctions related to products placed in the show, with the auctions being identified by unique auction_ID numbers.

The customer database 49 stores the details of each customer using the central administration server 1. As shown in FIG. 6, an entry 171 in the customer database 49 has:
a customer_ID field 173 storing a unique number assigned to the customer by the central administration server 1;
a customer_name field 175 storing the name of the customer;
an electronic_contact_info field 177 storing the email address and, if available, the cellular phone number for the customer;
a customer_password field storing a password which is used to verify the identity of the customer;
a billing_address field 181 which stores the billing address for the customer;
a delivery_address field 183 which stores the address to which products for the customer should be delivered; and

a credit_card details field 185 which stores the credit card details for the customer.

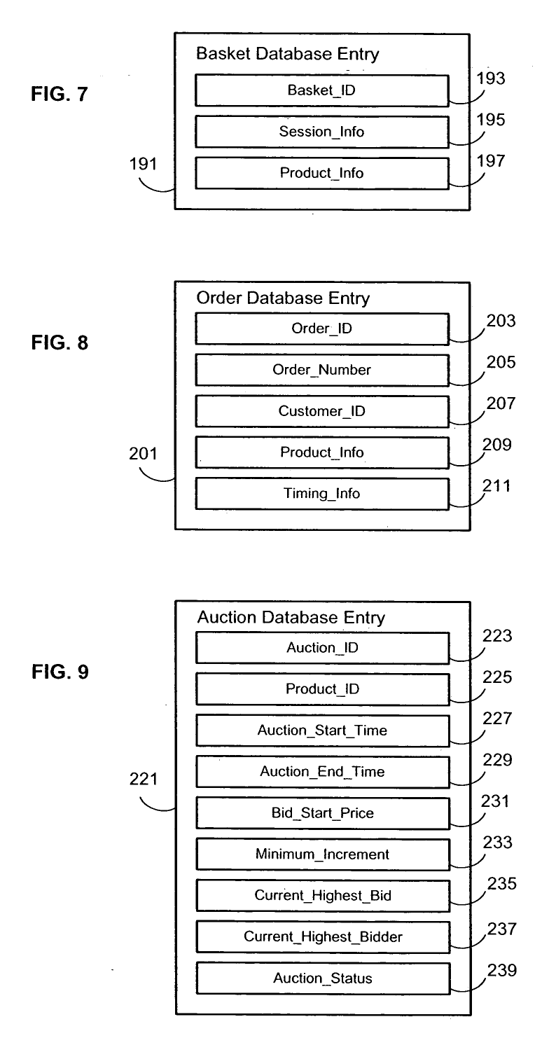

The basket database 51 stores details of each customer visit in which a customer indicates interest in a product by placing the product in a virtual shopping basket. As shown in FIG. 7, an entry 191 in the basket database 51 has:
a basket_ID field 193 storing a unique number assigned to the entry by the central administration server 1;
a session_info field 195 storing information relating to the session in which the basket database entry was created, including the time of the session; and
a product_info field 197 storing a list of the unique product_ID numbers corresponding to the products placed in the virtual shopping basket by the customer.

The order database 53 stores details of each order made. As shown in FIG. 8, an entry 201 in the order database 53 has:
an order_ID field 203 storing a unique number assigned to the entry by the central administration server 1;
an order_number field 205 storing an order number for transmission to the customer and the vendor;
a customer_ID field 207 storing the unique customer_ID number for the customer making the order;
a product_info field 209 storing the list of unique product_ID numbers corresponding to the products in the order;
a timing_info field 211 storing a time stamp indicative of when the order was made.

The auction database 55 stores details of each auction. As shown in FIG. 9, an entry 221 in the auction database 55 has:
an auction_ID field 223 storing a unique number assigned to the entry by the central administration server 1;
a product_ID field 225 storing the unique product_ID number for the product being auctioned;
an auction_start_time field 227 storing a time after which bids may validly be made;
an auction_end_time field 229 storing a time when the auction closes and no more bids may be made;
a bid_start_price field 231 storing an initial bid amount above which a bid amount must be to be valid;
a minimum_increment field 233 storing the minimum amount by which the amount bid may be raised;
a current_highest_bid field 235 storing the amount of the highest bid made;
a current_highest_bidder field 237 storing the unique customer_ID number for the customer who made the highest bid;
an auction status field 239 storing data indicating the status of the auction.

Returning to FIG. 2, the interfaces memory 41 stores interface software enabling the central administration server 1 to communicate, via the network interface 23, with customer computers 3, customer interactive televisions 5, customer cellular phones 7 and vendor servers 17. In particular, the interfaces memory 41 stores interactive TV interface software 81, internet interface software 83 and mobile interface software 85.

The interactive TV interface software 81 includes templates for displaying information on the customer interactive television 5 in response to requests received from the customer interactive television 5 via the interactive television network 13 and the interactive television adapter 15. In particular, in response to a request the central administration server 1 outputs a corresponding template, with each template having a number of fields into which data from the database memory 37 is input in dependence on the received request. For example, the fields may relate to product names and thumbnail images for products associated with a television show which is identified by the received request as being currently shown on the customer interactive television 5.

In this embodiment, the interactive television adapter 15 is provided remote from the central administration server 1. The reason for this is that access to an interactive television network 13 is strictly controlled, with various companies which are approved by the owner of the interactive television network having extended access rights. In this embodiment, the interactive television adapter 15 is operated by such an approved company.

The internet interface 83 includes web server software and multiple page templates in HTML format. Each HTML page template includes data fields in which data from the database memory 37 may be inserted in response to received customer requests. In a similar manner, the mobile interface 85 includes WAP server software and multiple page templates in WML format. Again, each WML page template includes data fields in which data from the database memory 37 may be inserted in response to received customer requests.

The routines memory 39 stores a Master_Control routine 61 which controls the overall operation of the central administration server 1 by monitoring for interrupts indicating that a processing operation is required, and then initiating the required processing operation. These processing operations are implemented using a number of sub-routines in the routines memory 39. In particular, the sub-routines are:
a Register_Vendor sub-routine 63;
a Product_Download sub-routine 65;
a Register_Show sub-routine 67;
a Place_Product sub-routine 69;
a New_Session sub-routine 71;
a Product_Purchase sub-routine 73;
an Auction_Bid sub-routine 75;
an Auction_Result sub-routine 77; and
a Register_Customer sub-routine 79.

Each of these sub-routines will now be discussed in detail.

The Register_Vendor Sub-Routine

The Register_Vendor sub-routine 63 is initiated in response to an instruction received from the operator of the central administration server 1 via the operator interface 21. The Register_Vendor sub-routine 63 causes a data entry form to be displayed on a display forming part of the operator interface 21, the form including data input fields into which the name of the vendor and information about the address of the vendor are input by the operator of the central administration server 1 using a keyboard which also forms a part of the operator interface 21. When the data entry fields of the displayed form have been completed, a new entry 101 in the vendor database 43 is created and assigned a unique Vendor_ID number which is stored in the Vendor_ID field 103, the name of the vendor is stored in the Vendor_Name field 105, the address information of the vendor is stored in the Address_Info field 107 and an active status is stored in the Status_Info field 109.

The Product_Download Sub-Routine

The Product_Download sub-routine 65 is initiated in response to product information being received from one of the vendor servers 17 via the network interface 23. In this embodiment, the product information is received in XML format. For each new product identified in the received product information, a new entry 121 in the product database 45 is created, with a unique Product_ID number being stored in the Product_ID field 123 and the remaining fields being completed using information provided by the vendor in the received product information.

The Register_Show Sub-Routine

The Register_Show Sub-Routine 67 is initiated in response to an instruction received from the operator of the central administration server 1 via the operator interface 21. The Register_Show sub-routine 67 causes a data entry form to be displayed on the display forming part of the operator interface 21, the form including data input fields into which the name of the show, information about the show and a description of the show are input by the operator of the central administration server 1 using the keyboard forming part of the operator interface 21. When the data entry fields of the displayed form have been completed, a new entry 151 in the show database 47 is created and assigned a unique Show_ID number which is stored in the Show_ID field 153, the name of the show is stored in the Show_Name field 105, the information about the show is stored in the Show_Info field 157 and the description of the show is stored in the Show_Description field 159.

The Place_Product Sub-Routine

The Place_Product sub-routine 69 is initiated in response to an instruction received from the operator of the central administration server 1 via the operator interface 21. The Place_Product sub-routine 69 causes a data entry form to be displayed on the display forming part of the operator interface 21, the form including a data input field into which the name of a show is input and a data input field into which the name of a product is input. The form also includes a data input field for indicating if the product is for purchase or for auction.

When the data entry form has been completed, if the product is for purchase then the entry in the show database 47 corresponding to the input show name is accessed, and then the Product_ID number for the entry in the product database 45 corresponding to the input product name is added to the list of Product_ID numbers stored in the Associated_Products field 161 of the entry 151 in the show database 47. If the product is for auction, a new form is displayed on the display of the operator interface with data input fields for the operator to input the start and end times of the auction, an initial bid price, and a minimum bid increment amount. The central administration server 1 then generates a new entry 221 in the auction database 55, assigns the new entry a unique Auction_ID number, and enters the Product_ID number, start and end times for the auction, initial bid price and minimum bid amount in the appropriate fields of the new entry. The central administration server 1 then adds the Auction_ID number for the new entry to the list of Auction_ID numbers stored in the Associated_Auctions field 163 of the entry in the show database 47 for the show.

The New_Session Sub-Routine

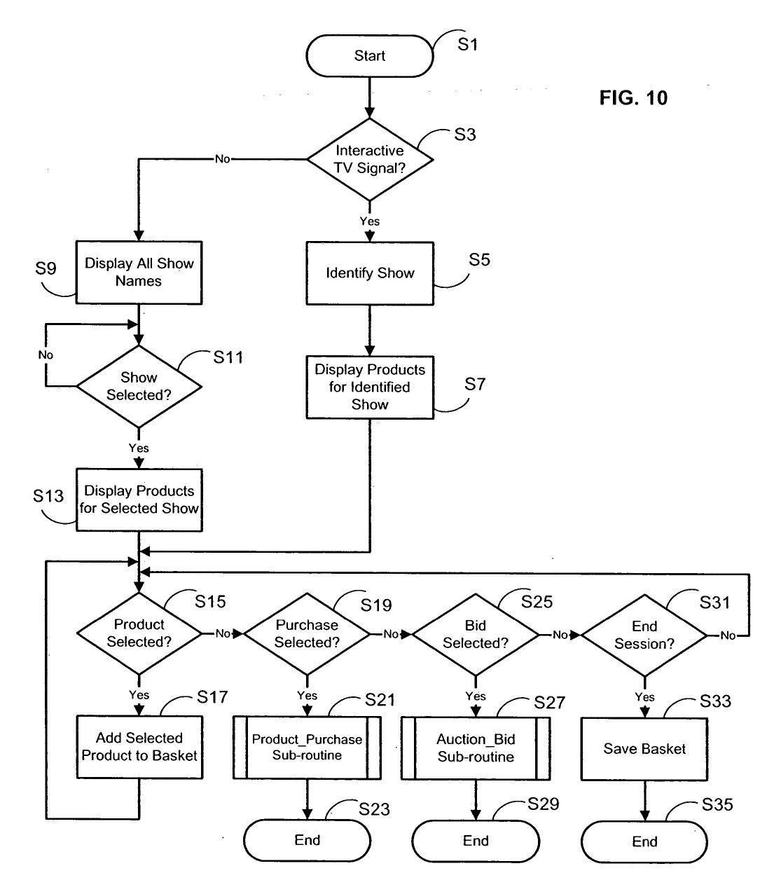

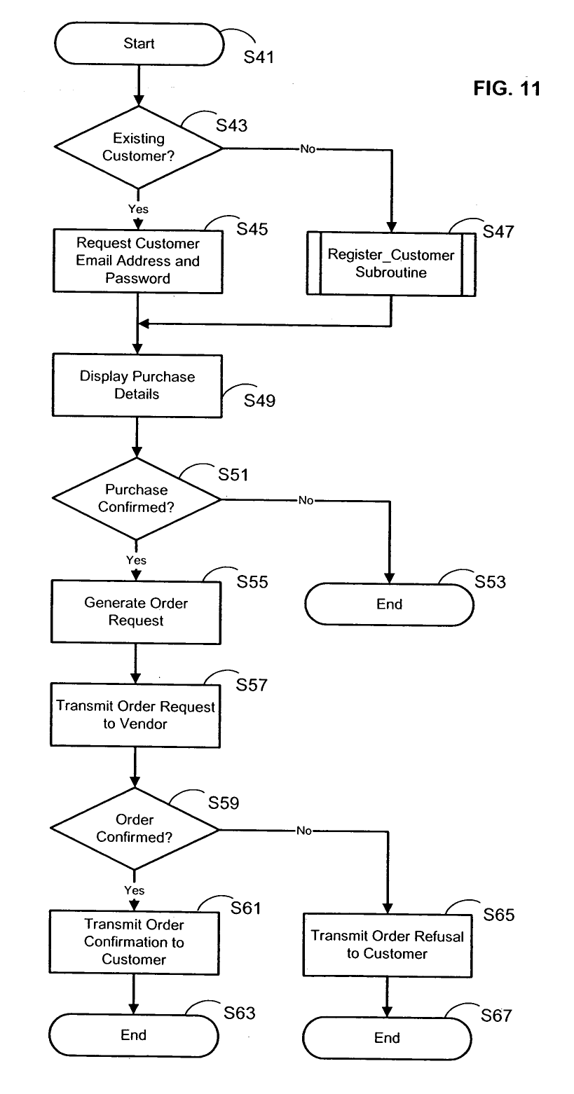

The New_Session sub-routine 71 is initiated in response to a customer accessing the central administration server 1 using a customer computer 3, a customer interactive television 5 or a customer cellular phone 7. The main operations of the New_Session sub-routine 71 will be described with reference to FIG. 10.

After the New_Session sub-routine 71 is initiated, at S1, the central administration server 1 determines the format of the received customer signal and then uses the appropriate interface software stored in the interfaces memory 41 for the remainder of the session. The central administration server 1 then checks, at S3, whether the customer for the session is using an interactive television 5. If the customer is using an interactive television, the central administration server 1 identifies, at S5, the show being watched on the interactive television from the return path signal. After identifying the show, the central administration server 1 determines the products associated with the show and the auctions associated with the show from the entries in the Associated_Products field 161 and the Associated_Auctions field 163 respectively of the entry in the show database 47 for the show, and outputs, at S7, a signal to cause the interactive television 5 to display the associated products for purchase and products for auction. In particular, the interactive TV interface 81 generates page data by inserting information retrieved from the entries in the product database 45 for the associated products for purchase and products for auction into a stored template.

If the central administration server 1 determines, at S3, that the customer for the session is not using an interactive TV, then the central administration server 1 outputs, at S9, a signal conveying a HTML page or a WML page (depending on whether the customer is using a computer 3 or a cellular phone 7) for displaying to the customer a list of all shows in the show database 47. The central administration server 1 then waits, at S11, until a signal is received from the customer selecting one of the shows. The central administration server 1 then outputs, at S13, an HTML page or a WML page listing the products for purchase and auction associated with the show.

After the products associated with a show have been displayed to the customer, the central administration server 1 waits for a signal from the customer. On receipt of a signal, the central administration server 1 checks, at S15, if the signal identifies selection of a product for purchase. If the signal does identify selection of a product for purchase, the central administration server 1 adds the selected product to the Product_Info field of the entry in the basket database 51 for the session. If the product is the first selected product for purchase for the session, then an entry for that session in the basket database 51 is created and assigned a unique Basket_ID number which is stored in the Basket_ID field 193, and session data is stored in the Session_Info field 195. After a selected product has been added to the session basket, the central administration server 1 waits for another signal from the customer.

On receipt of a signal from the customer, the central administration server 1 also checks, at S19, if the signal conveys a request to purchase the items stored in the Product_Info field 197 of the entry in the basket database 51 for the session. If the customer signal does convey a purchase request, then the central administration server 1 initiates, at S21, the Product_Purchase sub-routine 73 which is described in detail hereafter. After running the Product_Purchase sub-routine 73, the central administration server 1 ends, at S23, the session.

On receipt of a signal from the customer, the central administration server 1 also checks, at S25, if the signal conveys a request to make a bid for a product for auction. If the customer signal does convey a bid request, then the central administration server 1 initiates, at S27, the Auction_Bid sub-routine 75 which is described in detail hereafter. After running the Auction_Bid sub-routine 75, the central administration server 1 ends, at S29, the session.

On receipt of a signal from the customer, the central administration server 1 also checks, at S31, if the signal indicates that the customer is ending the session. If this is the case, the central administration server 1 saves, at S33, the session basket entry in the basket database 51 and then the session ends, at S35. The session basket entry is saved for future analysis of customer shopping trends.

The Product_Purchase Sub-Routine

As discussed above, the Product_Purchase sub-routine 73 is initiated in response to a signal from a customer during a session indicating that the customer wishes to purchase the products added to the Product_Info field 197 for the entry in the basket database 51 for the session. The main operations of the Product_Purchase sub-routine 73 will be described with reference to FIG. 11.

After initiation, at S41, of the Product_Purchase sub-routine 73, the central administration server 1 sends a signal to the customer apparatus asking if the customer is an existing customer and checks, at S43, the response. If the customer is an existing customer, the central administration server 1 sends, at S45, a request to the customer apparatus for the customer email address and password. On receiving the customer email address and password, the central administration server 1 finds the entry in the customer database 49 having the received email address stored in the Email_Address field 177, and confirms that the password stored in the Customer_Password field 179 for that entry matches the received password. If the customer is not an existing customer, the central administration server 1 initiates, at S47, the Register_Customer sub-routine 79, which will be described in detail hereafter.

After establishing the identity of the customer, the central administration server 1 sends, at S49, a signal to the customer apparatus causing the customer apparatus to display the purchase details and a request for confirmation of the purchase. The central administration server checks, at S51, the response to the request for purchase confirmation and if the purchase is not confirmed the sub-routine ends, at S53.

If the purchase is confirmed, then the central administration server 1 generates, at S55, one or more order requests and an entry in the order database 53. Each order request is associated with a particular vendor and includes details of the customer and the products from that vendor ordered by the customer. In particular, the order request includes the billing address, the delivery address and the credit card details stored in the entry for the customer in the customer database 49. The central administration server 1 then transmits, at S57, the one or more order requests to the respective vendor server 17 for the one or more associated vendors. Given the confidential nature of the customer information transmitted, this transmission is performed over a secure communication channel.

On receiving an order request, the vendor server 17 verifies the availability of the product and also verifies the billing details for the customer in a conventional manner. If the availability of the product and the billing details are confirmed, the vendor server 17 sends an order confirmation signal to the central administration server 1. Otherwise, the vendor server 17 sends an order denial signal to the central administration server 1.

On receiving a signal from a vendor server 17, the central administration server checks, at S59, if the order has been confirmed. If the order has been confirmed, then the central administration server 1 transmits, at S61, an order confirmation signal to the customer apparatus and the sub routine ends, at S63. If the order is not confirmed, then the central administration server sends, at S65, an order refusal signal to the customer apparatus and the sub-routine ends, at S67.

The Auction_Bid Sub-Routine

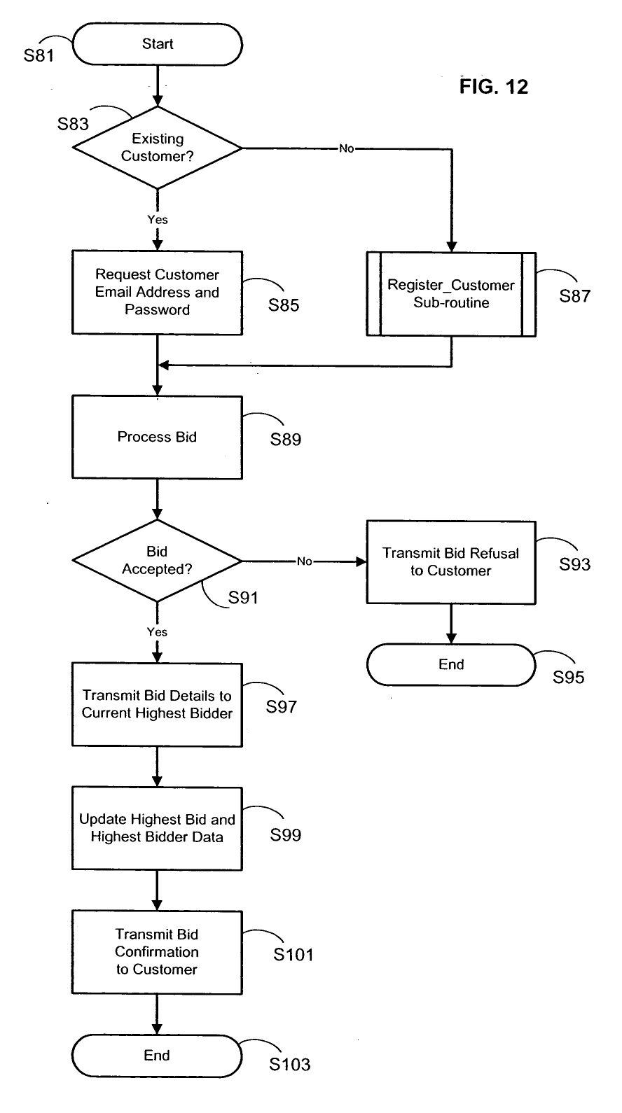

The Auction_Bid sub-routine 75 is initiated in response to a signal from a customer during a session indicating that the customer wishes to make a bid for a product which is up for auction. The main operations of the Auction_Bid sub-routine 75 will be described with reference to FIG. 12.

After initiation, at S81, of the Auction_Bid sub-routine 75, the central administration server 1 sends a signal to the customer apparatus asking if the customer is an existing customer and checks, at S83, the response. If the customer is an existing customer, the central administration server 1 sends, at S85, a request to the customer apparatus for the customer email address and password. On receiving the customer email address and password, the central administration server 1 finds the entry in the customer database 49 having the received email address stored in the Email_Address field 177, and confirms that the password stored in the Customer_Password field 179 for that entry matches the received password. If the customer is not an existing customer, the central administration server 1 initiates, at S87, the Register_Customer sub-routine 79, which will be described in detail hereafter.

After establishing the identity of the customer, the central administration server 1 sends a signal conveying the start and end times for the auction, the starting price, the current highest bid and the minimum bid amount increment details from the entry in the auction database 55 for the auction, and requests a bid amount from the customer. On receiving a signal conveying a bid amount from the customer, the central administration server 1 processes, at S89, the bid to check that the bid was made between the start and end times of the auction and that the bid amount is greater than the current highest bid by an amount larger than the minimum bid amount increment. If these conditions are satisfied the central administration server 1 accepts, at S91, the bid. If these conditions are not satisfied, the central administration server 1 transmits, at S93, a signal indicating refusal of the bid to the customer and ends, at S95, the session.

If the bid is accepted, the central administration server 1 accesses the entry in the customer database 49 corresponding to the Customer_ID number stored in the Current_Highest_Bidder field 235 of the entry in the auction database for the auction, and sends details of the new highest bid to the previous highest bidder using the email address stored in the Electronic_Contact_Info field 177. Further, in this embodiment if a cellular phone number is stored in the Electronic_Contact_Info field 177 then the central administration server also sends an SMS message to the cellular phone number giving details of the new highest bidder. In this way, the previous highest bidder is warned of the new highest bid and can consider making another bid.

After advising the previous highest bidder, the central administration server 1 updates, at S99, the entry in the auction database 55 by replacing the details in the Current_Highest_Bid field 235 and Cureent_Highest_Bidder field 237 with the amount of the new highest bid and the Customer_ID number of the customer for the session respectively. The central administration server then transmits, at S101, a signal to the customer confirming that the customer has the present highest bid, and then ends, at S103, the session.

The Auction_Result Sub-Routine

The Auction_Result sub-routine 77 is initiated when the internal timer of the central administration server 1 reaches the time stored in the Auction_End_Time field 229 for an auction.

On initiation of the Auction_Result sub-routine 77, the central administration server 1 stores data indicating that the auction is closed in the Auction_Status field 239. The central administration server 1 then generates an order request and an entry in the order database 53. Each order request is associated with the vendor for the product under auction, and includes details of the customer who made the highest bid and the amount of the highest bid. In particular, the order request includes the billing address, the delivery address and the credit card details stored in the entry in the customer database 49 for the customer who made the highest bid. The central administration server 1 then transmits the order request to the respective vendor server 17 for the associated vendor. Given the confidential nature of the customer information transmitted, this transmission is performed over a secure communication channel.

On receiving an order request, the vendor server 17 verifies the availability of the product and also verifies the billing details for the customer in a conventional manner. If the availability of the product and the billing details are confirmed, the vendor server 17 sends an order confirmation signal to the central administration server 1. Otherwise, the vendor server 17 sends an order denial signal to the central administration server 1.

On receiving a signal from a vendor server 17, the central administration server checks if the order has been confirmed. If the order has been confirmed, then the central administration server 1 transmits an order confirmation signal to the customer apparatus and the sub-routine ends. On the other hand, if the order is not confirmed then the central administration server sends an order refusal signal to the customer apparatus and the sub-routine ends.

The Register_Customer Sub-Routine

As discussed above, the Register_Customer sub-routine 79 is initiated during the Product_Purchase sub-routine 73 or the Auction_Bid sub-routine 75 if the customer is not an existing customer. On initiation of the Register_Customer sub-routine 79, the central administration server 1 transmits a data entry form to the customer apparatus requesting the customer to enter their name, email address, a password, a billing address, a delivery address and their credit card details. Given the confidential nature of this information, for the purposes of the Register_Customer sub-routine 79 a secure connection is established between the central administration server 1 and the customer apparatus.

After the customer has entered the requested customer information, the customer transmits the customer information to the central administration server 1, which then creates a new entry in the customer database 49 for the customer, assigns a unique Customer_ID number to the entry and stores the unique Customer_ID number in the Customer_ID field 173 for the created entry, and stores the received customer information in the corresponding fields of the created entry.

The System in Operation

As discussed above, in this embodiment vendors upload product information into the central administration server 1. The administration company running the central administration server 1 then provides details of products to producers of television shows, who select products for inclusion in the television shows. In order to aid selection of products, the short description of the product may include keywords allowing searching of the product database for certain types of product. The products associated with each television show are then stored in the show database 47.

After selecting products for inclusion in the television show, the producers make the television shows and generate data signals for broadcasting the television show on an interactive television network. Data for the interactive features associated with the television shows is also generated, including data defining that when the red button on the remote control for an interactive television is pressed a link is established with the central administration server 1.

A viewer watching a television show has a choice of ways in which to purchase, or bid for, products placed in the television show. If the viewer has an interactive television, the viewer may access the central administration server 1 by pressing the red button on the remote control of the interactive television. Alternatively, the viewer may access the central administration server using a computer or a cellular phone as discussed above. In this way, a viewer is able to find out details of a product placed in a television show quickly and easily, and purchase that product if desired.

Modifications and Further Embodiments

Although in the illustrated embodiment an interactive television adapter 15 is provided remote from the central administration server 1 to take advantage of the extended access rights to the interactive television network 13, this is not essential. In an alternative embodiment, the central administration server is able to communicate directly with the interactive television network 1.

In the illustrated embodiment, cellular phones access product information stored in the central administration server and instruct operations to be performed using conventional browser software. In an alternative embodiment, the central administration server stores a software application (for example a Java application) containing (i) product information for products associated with a television show and (ii) an emulator which, which when run on a cellular phone, simulates accessing of the product information as though it was product information stored on a server being accessed by a browser, but causes the cellular phone to communicate with the central administration server using a messaging service such as the SMS messaging service provided by the GSM communications protocol instead of a mobile internet protocol such as GPRS. In a particular embodiment, on seeing a product in a television show, the customer sends an SMS message to the central administration server identifying the television show. The central administration server then sends details of a mobile internet address (e.g. a URL) from which the Java application may be downloaded. The customer then uses the mobile internet functionality of the cellular phone to access the identified mobile internet address to download the Java application from the central administration server. On running the Java application, the customer interacts with the Java application in the same manner as if using a web browser, but the “web” pages are actually data stored in the Java application on the cellular phone. When the customer completes an order, the order information is sent to the central administration server as an SMS message. If the product information for the television show is updated, the central administration server sends an SMS message to the cellular phone advising that an updated Java application should be downloaded.

In a modified version of the illustrated embodiment, when the vendor server uploads product information to the central administration server, the product information includes stock information identifying the number of products in stock. The central administration server is then able to keep track of orders and when no more stock is available, advise customers of that fact.

In the illustrated embodiment, when a product is placed in a television show an operator of the central administration server 1 enters data into the central administration server 1 associating the product with the television show. In an alternative embodiment, producers of television shows may access the central administration server in order to view a list of products, and then transmit signals identifying the products to be placed in the television show directly to the central administration server, which associates the identified products with the television show automatically. The categorisation data stored in the category_info field 137 in each product database entry 121 may be used to facilitate searching for particular types of products.

In the illustrated embodiment, products are placed in television shows. These televisions shows could be viewed on conventional television sets (whether cathode ray tube, plasma, LCD or any other type), interactive television sets, personal computers (whether by web broadcast or any other means), large screen devices for public display, mobile devices for personal viewing, or any other suitable display device.

It will be appreciated that the products may be placed in other media events, such as films or plays. Alternatively, products could be placed in print media, for example editorial or advertising within magazines, newspapers, catalogues and company brochures with the central administration server including links to the various different print media to allow identification of products placed in each print medium.

Further, products could be placed in live events such as sporting events and concerts, with the central administration server including links between the live event and the products associated with that live event. Products could also be placed in the television coverage for a live event.

Products could also be placed in computer games with the administration server being operable to provide details of products placed in a computer game.

Alternatively, the central administration server could associate products directly with the vendors, so that a customer identifies a vendor and the central administration server provides details of products provided by that vendor.

The central administration server could also be used in conjunction with outdoor advertising such as billboards, giant screens and posters. Each advertisement includes an identification code which can be sent to the central administration server by a customer, in response to which the central administration server provides details of the product. The identification code could be written on the advertisement. Alternatively, the identification code could be included in a barcode associated the advertisement which may be read by a conventional barcode reader which preferably forms part of a device which is operable to access the mobile internet. The identification code could also be written in a magnetic strip or an RFID tag associated with the advertisement, which may respectively be read by a conventional magnetic strip reader or a conventional RFID tag reader which preferably form part of a device which is operable to access the mobile internet. As another alternative, the identification code could be transmitted by a Bluetooth (or other RF communications protocol) device associated with the advertisement to a nearby Bluetooth device, preferably also able to access the mobile internet, associated with the consumer.

As described above, there are many ways in which a consumer may become aware of a product. When the central administration server stores details of a large number of products, it is important to classify products based on how consumers are exposed to that product so that a user may quickly retrieve the details of a product based on how the consumer was exposed to that product, for example by entering the name of a television show in which the consumer saw the product.

As discussed above, one sales channel is the mobile internet, with the customer being able to access the mobile internet through a suitable cellular phone (sometimes called mobile phone, cell phone or the like). The phrase cellular phone covers any device operable to access the mobile internet, and therefore also covers suitably enabled personal digital assistants (PDAs) and the like. The term mobile internet covers the transmission of textual information between a client device and a remote network device in which the transmission link to the client device uses free-space radio waves.

Although the described embodiment of the invention comprises computer apparatus and processes performed in the computer apparatus, the invention also extends to computer programs, particularly computer programs on or in a carrier, adapted for putting the invention into practice. The program may be in the form of source code, object code, a code intermediate source and object codes such as in a partially compiled form, or in any other form suitable for using the implementation of the processes according to the invention.

The carrier may be any entity or device capable of carrying the program. For example, the carrier may comprise a storage medium, such as a ROM, for example a CD-ROM or a semi-conductor ROM, or a magnetic recording medium, for example a floppy disk, or a hard disk. Further, the carrier may be a transmissible carrier such as an electronic or optical signal which may be conveyed via electrical or optical cable or by radio or other means.

When the program is embodied in a signal which may be conveyed directly by cable or other device or means, the carrier may be constituted by such cable or other device or means. Alternatively, the carrier may be an integrated circuit in which the program is embedded, the integrated circuit being adapted for performing, or for use in the performance of, the relevant processes.

Although in the described embodiments the invention is implemented using software, it will be appreciated that alternatively the invention could be implemented using hardware devices, or a combination of hardware devices and software.

1. A network apparatus comprising:
a data store operable to store product information conveyed by a network signal received from a vendor, said product information being associated with a plurality of products;
a classifier operable to classify products associated with the stored product information under one or more classifications in accordance with received classification information; and
a signal generator operable to generate a network signal identifying products classified in a classification for transmission to a remote network apparatus in response to a received request from the remote network device,
wherein said signal generator is operable to format said signal for transmission in one of a plurality of different formats in dependence on at least one of the format of and the content of the received request.

2. A network apparatus according to claim 1, wherein the classifier is operable to classify products under classifications associated with respective different viewing experiences.

3. A network apparatus according to claim 2, wherein at least one of the classifications corresponds to a television show.

4. A network apparatus according to claim 1, wherein at least one of the classifications corresponds to a live event.

5. A network apparatus according to claim 1, wherein the signal generator is operable to generate a signal in HTML format.

6. A network apparatus according to claim 1, wherein the signal generator is operable to generate a signal in WML format.

7. A network apparatus according to claim 1, wherein the signal generator is operable to generate a signal in an interactive television format.

8. A network apparatus according to claim 1, further comprising:
a data store operable to store auction data associated with a product; and
a bid processor operable to process a received network signal conveying bid data corresponding to a bid for the product using the stored auction data.

9. A network apparatus according to claim 8, wherein the auction data comprises highest bid amount data and the bid processor is operable to compare a bid amount specified by the received bid data with the stored highest bid amount data, and if the bid amount is greater than the value of the highest bid amount data to replace the value of the highest bid amount data with said bid amount.

10. A system comprising a network device and a plurality of customer terminals interconnected by a network, the network device comprising:
a data store operable to store product information conveyed by a network signal received from a vendor, said product information being associated with a plurality of products;
a classifier operable to classify products associated with the stored product information under one or more classifications in accordance with received classification information; and
a signal generator operable to generate a network signal identifying products classified in a classification for transmission to one of the customer terminals in response to a received request from that customer terminal,
wherein said signal generator is operable to format said signal for transmission in one of a plurality of different formats in dependence on at least one of the format of and the content of the received request.

11. A system according to claim 10, wherein the customer devices include interactive televisions.

12. A system according to claim 10, wherein the customer devices include devices which are operable to access the internet.

13. A system according to claim 10, wherein the customer devices include portable devices which are operable to access the internet using radio frequency signals.

14. A system according to claim 13, wherein said portable devices include cellular phones.

15. An electronic auction system comprising:
a central administration server; and
a plurality of portable bidding terminals, each bidding terminal comprising a wireless communicator for enabling communication between the bidding terminal and the central administration server,
wherein the central administration server comprises:
a data store operable to store details of one or more auctions, said details including the current highest bid price; and
a processor operable to process a signal received from a bidding terminal conveying a bid for an auction.

16. An electronic auction system according to claim 15, wherein the plurality of portable bidding terminals includes one or more cellular phones.

17. An electronic auction system according to claim 16, wherein the cellular phone is operable to communicate with the central administration server using the Wireless Application Protocol.

18. An electronic auction system according to claim 15, wherein the data store of the central administration server is arranged to store an identifier for the maker of the highest bid of an auction, said identifier comprising address information for a portable bidding terminal,
and wherein after receiving a signal conveying a new highest bid, the processor of the central administration server is arranged to send a signal conveying the amount of the new highest bid to the portable bidding terminal associated with the maker of the previous highest bid.

19. A method of operation of a network apparatus, the method comprising:
receiving a network signal conveying product information from a vendor;
storing said product information in a data store;
classifying the product associated with the product information under one or more classifications in accordance with a received classification signal;
receiving a signal from a remote customer device in one of a plurality of different signal formats, said signal requesting details of products in a classification; and
generating and transmitting to the remote device a signal identifying products in the requested classification in a signal format determined by at least one of the signal format and the content of the signal received from the remote customer device.

20. A method according to claim 19, wherein in said classifying step the product is classified in a classification associated with a television show in which the product appears.

21. A method according to claim 19, wherein in the classifying step the product is classified in a classification associated with a live event in which the product appears.

22. A method according to claim 19, wherein in the generating and transmitting step, the signal identifying products in a classification is generated in HTML format.

23. A method according to claim 19, wherein in the generating and transmitting step, the signal identifying products in a classification is generated in WML format.

24. A method according to claim 19, wherein in the generating and transmitting step, the signal identifying products in a classification is generated in an interactive television format.

25. A storage device storing instructions including instructions for programming a programmable processing apparatus to implement a method according to any of claims 19 to 24.

26. A signal conveying instructions including instructions for programming a programmable processing apparatus to implement a method according to any of claims 19 to 24.

27. A signal conveying:
data defining a plurality of display pages; and
instructions including instructions for programming a programmable processing apparatus to access and display selected display pages in response to user inputs in a manner emulating web browser software, and in response to a predetermined user input to generate an output signal for transmission to a remote apparatus.

28. A signal according to claim 27, wherein the data and applications form a Java application.

29. A signal according to claim 27, wherein the instructions are operable to cause a cellular phone to output a signal using a messaging service.

30. A signal according to claim 29, wherein the messaging service is the SMS messaging service provided in the GSM specification.

31. A storage device storing:
data defining a plurality of display pages; and
instructions including instructions for programming a programmable processing apparatus to access and display selected display pages in response to user inputs in a manner emulating web browser software, and in response to a predetermined user input to generate an output signal for transmission to a remote apparatus.

32. A storage device according to claim 31, wherein the data and applications form a Java application.

33. A storage device according to claim 31, wherein the instructions are operable to cause a cellular phone to output a signal using a messaging service.

34. A storage device according to claim 33, wherein the messaging service is the SMS messaging service provided in the GSM specification.

35. A cellular phone comprising a storage device storing:
data defining a plurality of display pages; and
instructions including instructions for programming a programmable processing apparatus to access and display selected display pages in response to user inputs in a manner emulating web browser software, and in response to a predetermined user input to generate an output signal for transmission to a remote apparatus.
